(19) United States
(12) Patent Application Publication
(10) Pub. No.: US 2026/0029728 A1
(43) Pub. Date: Jan. 29, 2026

(54) TONER

(71) Applicant: CANON KABUSHIKI KAISHA, Tokyo (JP)

(72) Inventors: YOSUKE IWASAKI, Chiba (JP); YURI YAMABAYASHI, Chiba (JP); YOSHIHIRO OGAWA, Kanagawa (JP)

(21) Appl. No.: 19/268,680

(22) Filed: Jul. 14, 2025

(30) Foreign Application Priority Data
Jul. 26, 2024 (JP) 2024-120910

(51) Int. Cl. G03G 9/08; G03G 9/083; G03G 9/093

(52) U.S. Cl. CPC G03G 9/0819; G03G 9/0833; G03G 9/0839; G03G 9/09328

(57) ABSTRACT

A toner includes toner particles individually containing a binder resin and a coloring agent, and strontium titanate fine particles. The strontium titanate fine particles have a work function of 5.65 eV to 7.00 eV.

### BACKGROUND

### Field of the Technology

The present disclosure relates to a toner used in electrophotographic methods, electrostatic recording methods, electrostatic printing methods, and toner jet methods.

### Description of the Related Art

With widespread use of copiers and printers, the performance required for toners has become more sophisticated. In recent years, a digital printing technique known as print-on-demand (POD), which prints directly without any plate-making process, has been attracting attention. POD is more advantageous than conventional offset printing in terms of supporting: small batch printing, printing different content on each sheet, and distributed printing. For applying an image-forming method using toner to the POD market, the method is required to consistently produce high-quality printed results, even when output is made in a large quantity at a high speed over a long time.

In addition, toner that can maintain high chargeability in various environments is demanded to produce high-quality printed results, even when output is made in a large quantity at a high speed over a long time.

The technique of externally adding inorganic fine particles to toner particles has been used to impart high chargeability and high flowability, and silica fine particles have been widely used as such an external additive. Separately, to improve the properties for cleaning the toner, various external additives with different compositions from silica fine particles are also studied. In particular, strontium titanate fine particles, which are greatly different in crystal structure, shape, and chargeability from silica fine particles, attract attention.

Japanese Patent Laid-Open No. 2015-137208 suggests a toner including strontium titanate-based fine particles as an external additive. The fine particles are in the shape of a cubic or rectangular solid, and have a SrO/TiO₂ mole ratio of 0.80 or more and less than 0.95 and a narrow primary particle size distribution. As with other external additives, strontium titanate is often subjected to hydrophobization. The above-cited literature suggests strontium titanate surface-treated with a silane coupling agent or silicone oil. Japanese Patent Laid-Open No. 2005-173208 suggests the case of titanium oxide fine particles subjected to silane coupling treatment and silicone oil treatment in combination.

From the viewpoint of enhancing chargeability, an approach to increasing the work function of the external additives can be taken. When the work function is increased, electrons are difficult to release during contact charging between different materials. Thus, the toner is likely to maintain a negative charge. Japanese Patent Laid-Open No. 2007-93732 suggests a type of strontium titanate with a high work function of 5.6 eV.

Japanese Patent Laid-Open Nos. 2005-173208 and 2007-93732 of the above-cited literature include evaluations based on endurance printing. However, the toners using the techniques described in the cited literature do not achieve the recent target value for high chargeability, and further improvement is required. In other words, toner that can maintain high chargeability independent of environments is demanded to consistently produce high-quality printed results, even when output is made in a large quantity at a high speed over a long time.

### SUMMARY

The present disclosure provides a toner that exhibits excellent chargeability even when output is made in a large quantity at a high speed over a long time.

The present disclosure is directed to a toner that includes toner particles individually containing a binder resin and a coloring agent, and strontium titanate fine particles. The strontium titanate fine particles have a work function of 5.65 eV to 7.00 eV.

Features of the present disclosure will become apparent from the following description of embodiments with reference to the attached drawings. The following description of embodiments is described by way of example.

### BRIEF DESCRIPTION OF THE DRAWINGS

FIG. 1A is a plan view of a cell for measuring powder.

FIG. 1B is a side view of the cell for measuring powder.

FIG. 1C is a perspective view of the cell for measuring powder.

FIG. 2 is a schematic illustrative representation of a surface analysis method.

### DESCRIPTION OF THE EMBODIMENTS

### Significance and Features of the Disclosure

The present inventors found through their intensive research that a toner that includes toner particles individually containing a binder resin and a coloring agent, and strontium titanate fine particles with a work function of 5.65 eV to 7.00 eV exhibits excellent chargeability and can achieve high image quality.

Although the reason for the advantageous effects of the present disclosure is not clear, the present inventors assume the mechanism to be as follows.

It is essential for the strontium titanate fine particles used herein to have a work function of 5.65 eV to 7.00 eV. The work function of strontium titanate fine particles indicates the ease of electron release. By controlling the work function within a specific range, the toner is improved in regulating its charge amount.

The present inventors suppose that strontium titanate fine particles with a work function in the above range, when attached to toner particles, are less likely to restrain electrons and consequently bring the toner into a state that the toner easily retains electrons as a whole, enhancing the chargeability of the toner as a whole. The work function of the strontium titanate fine particles is preferably 5.70 eV or more, more preferably 5.75 eV or more.

The strontium titanate fine particles with a work function of 5.65 eV or more tend to retain electrons and thus allow the toner to maintain the charge amount at a certain high level or more. Even under conditions where the charge amount of the toner tends to decrease, for example, particularly in high-humidity environments or particularly when a large quantity of images with high print coverage is printed, the toner can maintain a high charge amount.

In addition, since the high chargeability is maintained, the transferability can be enhanced. Consequently, transfer voids, which are phenomena in which part of the toner image in the center of characters is not transferred and results in a missing area during transfer, can be prevented.

When the work function is 7.00 eV or less, the strontium titanate fine particles can reasonably release electrons, thus preventing the toner from being excessively charged. Even under conditions where the charge amount of the toner tends to be excessive, for example, in low-humidity environments or when a large quantity of images with low print coverage is printed, the toner can maintain a proper charge amount. Maintaining a proper charge amount of the toner prevents toner from sticking excessively to the photosensitive member, thereby enabling the toner to maintain its ease of removal.

### Preferred Embodiments of the Disclosure

Preferably, the strontium titanate fine particles according to the present disclosure are surface-treated from the viewpoint of hydrophobization and chargeability.

For the surface treatment of the strontium titanate fine particles, a silane compound may be used. Examples of the silane compound include, but are not limited to, alkoxysilanes, such as methoxysilane, ethoxysilane, and propoxysilane, halosilanes, such as chlorosilane, bromosilane, and iodosilane, hydrosilanes, alkylsilanes, arylsilanes, vinylsilanes, acrylsilanes, epoxy silanes, silyl compounds, siloxanes, silyl ureas, silyl acetamides, and silane compounds with some of the varying substituents of these silane compounds.

Specific examples include trimethylsilane, trimethylchlorosilane, trimethylethoxysilane, dimethyldichlorosilane, methyltrichlorosilane, trialkoxyalkylsilane, allyldimethylchlorosilane, α-chloroethyltrichlorosilane, β-chloroethyltrichlorosilane, chloromethyldimethylchlorosilane, dimethyldiethoxysilane, dimethyldimethoxysilane, and hexamethyldisiloxane.

Alkyltrialkoxysilanes are particularly preferred in view of hydrophobization and chargeability. Among alkyltrialkoxysilanes, preferred options include methyltriethoxysilane, ethyltrimethoxysilane, n-propyltrimethoxysilane, isobutyltrimethoxysilane, n-hexyltrimethoxysilane, and n-octyltriethoxysilane. Those whose alkyl group has 3 to 6 carbon atoms are more preferred, and isobutyltrimethoxysilane is still more preferred.

The treatment process using a silane coupling agent is not limited and may be conducted by spraying a coupling agent onto the strontium titanate fine particles or mixing a vaporized coupling agent with the strontium titanate fine particles and then applying heat treatment. In such a process, water, an amine, or any other catalyst may be used. Surface modification, or surface treatment, using the above-mentioned coupling agents is performed preferably in an atmosphere of an inert gas, such as nitrogen. Also, a coupling agent, strontium titanate fine particles, and a solvent may be mixed, and the mixed solution may be heated or dried. In this instance, either the coupling agent or the strontium titanate fine particles may first be dispersed in the solvent, or all the constituents may be mixed at one time.

For particles with a primary particle size of 0.02 m to 0.3 m, those coated with a hydrophobization agent in an aqueous medium have higher dispersibility and thus are preferred. For treating the particles in an aqueous medium, preferably the silane coupling agent is adsorbed onto strontium titanate slurry in water, which is not restrictive.

For the surface treatment of the strontium titanate fine particles, silicone oil may be used. Examples of the silicone oil include, but are not limited to, dimethyl silicone oil, alkyl-modified silicone oil, α-methylstyrene-modified silicone oil, chlorophenyl silicone oil, and fluorine-modified silicone oil. The silicone oil preferably has a viscosity of 1.0×10⁻⁷ m²/s to 0.1 m²/s at 25° C.

Known techniques can be applied to the silicone oil treatment. For example, strontium titanate powder and silicone oil are mixed using a mixer. Alternatively, silicone oil may be applied onto strontium titanate powder with a spray, or silicone oil is dissolved in a solvent and then mixed with strontium titanate powder. The treatment is not limited to these methods.

For particles with a primary particle size of 0.02 m to 0.3 m, those coated with a hydrophobization agent in an aqueous medium have higher dispersibility and thus are preferred, as described above. When silicone oil is applied, a method is preferably used in which the silicone oil is emulsified in water using an emulsifier and, in this state, adsorbed onto strontium titanate slurry.

The surface treatment using a silane coupling agent is, preferably, followed by silicone oil treatment.

It has been found that the outermost surface of strontium titanate has molecular-level irregularities and that the outermost TiO₂ layer partially has voids. In other words, a SrO layer underlying the outermost TiO₂ layer is observed through the voids in the TiO₂ layer. The present inventors assume that in the silane coupling treatment, the silane coupling agent binds easily to the outermost TiO₂ layer, and that the surface including the SrO layer is treated so as to fill the voids by the subsequent silicone oil treatment. Thus, the present inventors believe that the combination of these two types of treatment enables maximal surface treatment.

The strontium titanate fine particles according to the present disclosure preferably have a number average particle size of 5 nm to 50 nm, which enhances the function of regulating the charge amount of the toner. More preferably, it is 10 nm to 40 nm.

The strontium titanate fine particle content of the toner is preferably 0.1% to 5.0% by mass, which enhances the function of regulating the charge amount of the toner. More preferably, it is 0.3% to 4.0% by mass.

The strontium titanate fine particles may be contained within the toner particles.

The toner in which strontium titanate fine particles are contained within the individual toner particles exhibits more excellent chargeability.

### Raw Materials of Toner

Raw materials of the toner used herein will now be described.

### Strontium Titanate Fine Particles

The strontium titanate fine particles may be produced by, but not limited to, a wet process or sintering. A wet process with high surface treatment efficiency is preferred.

Strontium titanate fine particles may contain a dopant. Preferred examples of the dopant of the strontium titanate fine particles include, but are not limited to, lanthanoids, silicon, aluminum, magnesium, calcium, barium, vanadium, chromium, manganese, iron, cobalt, nickel, copper, zinc, gallium, niobium, molybdenum, ruthenium, palladium, indium, antimony, tantalum, tungsten, rhenium, iridium, platinum, bismuth, yttrium, zirconium, silver, and tin. Lanthanum and cerium are preferred among the lanthanoids. Lanthanum and silicon have sizes that easily enter crystal structures and are therefore further preferred.

The strontium titanate fine particles according to the present disclosure can be produced, for example, through a normal-pressure heating reaction process. In this process, a mineral acid-peptized hydrolysate of a titanium compound is used as the titanium oxide source, and a water-soluble acidic metal compound is used as the source of strontium metal. The strontium titanate fine particles can be produced by reacting the mixture of these materials at 60° C. or higher while an alkaline aqueous solution is being added, followed by acid treatment.

### Normal-Pressure Heating Reaction Process

A mineral acid-peptized hydrolysate of a titanium compound is used as the titanium oxide source. The mineral acid-peptized hydrolysate is preferably such that metatitanic acid produced by a sulfate process with a SO₃ content of 1.0% by mass or less, preferably 0.5% by mass or less, is peptized with the pH adjusted to 0.8 to 1.5 with hydrochloric acid. Metatitanic acid with a SO₃ content higher than 1.0% by mass does not allow peptization to proceed and is thus not suitable.

Sources of metal other than titanium include metal nitrates and chlorides.

An example of metal nitrates is strontium nitrate. An example of metal chlorides is strontium chloride. In particular, strontium nitrate and strontium chloride are preferred in terms of charge stability in environments because strontium titanate fine particles produced using strontium nitrate or chloride have a perovskite crystal structure.

The alkaline aqueous solution may be a caustic alkali, particularly an aqueous solution of sodium hydroxide.

In the above production process, factors that affect the particle size of the resulting strontium titanate fine particles include the proportion of the titanium oxide source and strontium source mixed when reacted, the titanium oxide source concentration in the early stage of the reaction, and the temperature and rate of adding the alkaline aqueous solution. These factors may be appropriately controlled to obtain the targeted product with a desired particle size and particle size distribution. Preferably, the reaction is conducted under conditions that prevent contamination by carbon dioxide, for example, in a nitrogen gas atmosphere to prevent the production of carbonates during the reaction.

In the above production process, factors that affect the particle size distribution of the resulting strontium titanate fine particles include the pH for peptizing metatitanic acid with hydrochloric acid, the titanium oxide source concentration in the early stage of the reaction, and the rate, time, and stirring conditions of adding the alkaline aqueous solution. In particular, rapidly lowering the temperature of the reaction system after adding an alkaline solution, for example, by placing ice water in the reaction system, can forcibly stop the reaction during the saturation of crystal growth. This facilitates broadening the particle size distribution. Also, the particle size distribution tends to broaden when the reaction system is brought into a nonuniform state, for example, by reducing the stirring speed or changing the stirring method.

The proportion of the titanium oxide source and strontium source mixed when reacted, in terms of MxO/TiO₂ mole ratio, is preferably 0.90 to 1.40, more preferably 1.05 to 1.20, wherein M represents a metal other than titanium and x is 1 when M is an alkaline-earth metal and 2 when M is an alkali metal. If the MO/TiO₂ mole ratio is 1 or less, the reaction product is not only metal titanate but is also likely to contain unreacted titanium oxide. Metal sources other than titanium have relatively high solubilities in water, whereas titanium oxide sources are less soluble in water. Accordingly, if the MxO/TiO₂ mole ratio is 1 or less, the reaction product is not only metal titanate but is also likely to contain unreacted titanium oxide. The suitable titanium oxide source concentration in the early stage of the reaction is 0.05 mol/L to 1.30 mol/L, preferably 0.08 mol/L to 1.00 mol/L, in terms of TiO₂.

The suitable temperature at which the alkaline aqueous solution is added is, in practice, in the range of 60° C. to 100° C. Temperatures of 100° C. or more require a pressure vessel such as an autoclave. For the rate of adding the alkaline aqueous solution, the lower the addition rate, the larger the particle size of strontium titanate particles, and the higher the addition rate, the smaller the particle size of strontium titanate particles.

The rate of adding the alkaline aqueous solution can be appropriately adjusted depending on the desired particle size and is properly 0.001 equivalent/h to 1.2 equivalent/h, preferably 0.002 equivalent/h to 1.1 equivalent/h, relative to the raw materials.

### Acid Treatment

In the above production process, the strontium titanate fine particles obtained through a normal-pressure heating reaction are, preferably, further treated with an acid. When strontium titanate fine particles are synthesized by a normal-pressure heating reaction, if the proportion of the titanium oxide source and strontium source mixed exceeds 1.0 in terms of the MxO/TiO₂ mole ratio, the unreacted strontium source remaining after the reaction reacts with carbon dioxide in the air and produces strontium carbonate or other impurities. If the strontium carbonate or other impurities are left on the surface, the impurities interfere with the formation of a uniform coating of an organic surface treatment agent when it is applied to impart hydrophobicity to the surface. Accordingly, it is preferable to perform acid treatment to remove the unreacted metal source after adding the alkaline aqueous solution.

In the acid treatment, the pH is adjusted preferably to 2.5 to 7.0, more preferably to 4.5 to 6.0, with hydrochloric acid. The acid used for acid treatment other than hydrochloric acid may be nitric acid or acetic acid. Sulfuric acid is not suitable because it produces metal sulfates that are less soluble in water.

The coverage of the surface of the toner particles with the strontium titanate fine particles is preferably 2% or more. When the coverage of the surface of the toner particles with the strontium titanate fine particles is 2% or more, the charge is easily stabilized effectively in environments. More preferably, the coverage is 2% to 40% from the viewpoint of reducing image defects when strontium titanate fine particles are detached from the toner.

To mix the toner particles and the strontium titanate fine particles, a known mixer, such as Henschel Mixer (manufactured by Nippon Coke & Engineering Co., Ltd.), Mechano Hybrid (manufactured by Nippon Coke & Engineering Co., Ltd.), Super Mixer (manufactured by Kawata MFG. Co., Ltd.), and Nobilta (manufactured by Hosokawa Micron Corporation), may be used without particular limitation. Mixing conditions include the volume of materials to be treated, the rotational speed of the stirring shaft, the stirring time, the shape of a stirring blade, the tank temperature.

### Binder Resin

The binder resin used in toners for electrophotography may be a common resin, such as polyester resin, styrene-acrylic copolymer, polyolefin-based resin, vinyl-based resin, fluororesin, phenolic resin, silicone resin, or epoxy resin. Among these resins, amorphous polyester resin is used from the viewpoint of improving low-temperature fixability. Also, it is known that low-molecular-weight polyester and high-molecular-weight polyester are used in combination from the viewpoint of achieving both low-temperature fixability and hot offset resistance. From the viewpoint of blocking resistance in storage and further improvement of low-temperature fixability, crystalline polyester may be used as a plasticizer.

### Magnetic Iron Oxide Particles

The toner described herein may include magnetic iron oxide particles as presented below. Specific examples include magnetic iron oxide particles, such as magnetite, maghemite, and ferrite, and magnetic iron oxide particles containing any other metal oxide. Conventionally known such particles include triiron tetroxide (Fe₃O₄), iron sesquioxide (γ-Fe₂O₃), zinc iron oxide (ZnFe₂O₄), yttrium iron oxide (Y₃Fe₅O₁₂), cadmium iron oxide (Cd₃Fe₂O₄), gadolinium iron oxide (Gd₃Fe₅O₁₂), copper iron oxide (CuFe₂O₄), lead iron oxide (PbFe₁₂O₁₉), nickel iron oxide (NiFe₂O₄), neodymium iron oxide (NdFe₂O₃), barium iron oxide (BaFe₁₂O₁₉), magnesium iron oxide (MgFe₂O₄), manganese iron oxide (MnFe₂O₄), lanthanum iron oxide (LaFeO₃), and iron powder (Fe). Triiron tetroxide or 7-iron sesquioxide fine powder is particularly used as suitable magnetic iron oxide particles. The above-presented species of magnetic iron oxide particles may be selectively used in combination of two or more species.

### Coloring Agent

The following coloring agents can be used as the coloring agent contained in the toner particles.

Such coloring agents include known organic pigments and oil-based dyes, carbon blacks, and magnetic materials.

Cyan coloring agents include copper phthalocyanine and their derivatives, anthraquinone compounds, and basic dye lakes.

Magenta coloring agents include condensed azo compounds, diketopyrrolopyrrole compounds, anthraquinone compounds, quinacridone compounds, basic dye lakes, naphthol compounds, benzimidazolone compounds, thioindigo compounds, and perylene compounds.

Yellow coloring agents include condensed azo compounds, isoindolinone compounds, anthraquinone compounds, azo metal complexes, methine compounds, and allyl amide compounds.

Black coloring agents include carbon blacks, magnetic materials, and mixtures whose color is adjusted to black using yellow, magenta, and cyan coloring agents.

Such coloring agents may be used individually or in combination.

### Release Agent

A release agent may be used, as desired, to reduce hot offset phenomena during the heat fixing of the toner. Common examples of the release agent include low-molecular-weight polyolefins, silicone wax, fatty acid amides, ester wax, carnauba wax, hydrocarbon wax, and Fischer-Tropsch wax.

### Charge Control Agent

The toner particles according to the present disclosure may contain a charge control agent as desired. The charge control agent is preferably an aromatic carboxylic acid metal compound, which is colorless and enables the toner to be rapidly charged and stably holds a constant charge amount.

Negative charge control agents include salicylic acid metal compounds, naphthoic acid metal compounds, dicarboxylic acid metal compounds, polymeric compounds with sulfonic or carboxylic acid side chains, polymeric compounds with sulfonic acid salt or sulfonic ester side chains, polymeric compounds with carboxylic acid salt or carboxylic ester side chains, boron compounds, urea compounds, silicon compounds, and calixarene.

The charge control agent may be contained within the toner particles or externally added to the toner particles.

The amount of the charge control agent in the individual toner particles is preferably 0.01 parts by mass to 10 parts by mass relative to 100 parts by mass of the binder resin in the toner particles.

### Magnetic Carrier

The toner may be mixed with a magnetic carrier to be used as a toner of a two-component developer from the viewpoint of consistently producing images over an extended period.

Examples of the magnetic carrier include surface-oxidized or unoxidized iron powder, metal particles of iron, lithium, calcium, magnesium, nickel, copper, zinc, cobalt, manganese, and rare earth metals, alloy or oxide particles of these metals, magnetic materials such as ferrite, and magnetic material-dispersed resin carriers (what are called resin carriers) containing a magnetic material and a binder resin holding the magnetic material in a dispersed state.

### Method for Producing the Toner

The toner according to the present disclosure can be produced in known methods. The following describes the procedure for producing the toner by a melt kneading pulverization method.

In the step of mixing materials, the materials of the toner particles, including a binder resin, a coloring agent or a pigment dispersion, a wax, and optional materials, such as a charge control agent, are mixed in predetermined proportions. Examples of the mixer include double-cone mixers, V-shaped mixers, drum mixers, super mixers, Henschel mixers, Nauta mixers, and Mechano Hybrid (manufactured by Nippon Coke & Engineering Co., Ltd.)

Then, the mixture of the materials is melt-kneaded to disperse the magnetic material, coloring agent, and other materials in the binder resin.

In the step of melt-kneading, a batch-type kneading device, such as a pressure kneader or Banbury mixer, or a continuous kneading device can be used. Single-screw or twin-screw extruders are most commonly used because of their advantage of continuous production. Examples include KTK twin-screw extruder (manufactured by Kobe Steel, Ltd.), TEM twin-screw extruder (manufactured by Shibaura Machine Co., Ltd.), PCM kneader (manufactured by Ikegai Corp.), twin-screw extruder (manufactured by KCK), co-kneader (manufactured by Buss), and Kneadex (manufactured by Nippon Coke & Engineering Co., Ltd).

The kneaded material obtained by melt-kneading may be rolled with a two-roll mill or the like and cooled with water in a cooling step.

The cooled kneaded material is pulverized into particles with a desired particle size. In the pulverization step, the kneaded material is roughly crushed with a crusher and then further pulverized into finer particles with a pulverizer. Crushing machines used for rough crushing include, for example, crushers, hammer mills, and feather mills. Pulverization machines used for subsequent pulverization include, for example, Kryptron System (manufactured by Kawasaki Heavy Industries, Ltd.), Super Rotor (manufactured by Nisshin Engineering Inc.), turbo mills (manufactured by Freund Turbo), and air-jet pulverizers.

The resulting particles are optionally sized with a classifier or a sifter to obtain toner particles. Examples of the classifier or sifter include an inertial classification classifier Elbow-Jet (Nittetsu Mining), a centrifugal classifier Turboplex (manufactured by Hosokawa Micron), TSP Separator (manufactured by Hosokawa Micron), and Faculty (manufactured by Hosokwawa Micron).

After the pulverization, strontium titanate fine particles are added to the resulting toner particles and thus mixed with (externally added to) the toner particles to obtain the toner. In addition, other external additives, such as other known inorganic fine particles and resin particles, may be further added as desired, for example, to impart a flowability to the toner or adjust the chargeability.

If large aggregates of an additive remain in the resulting toner, the toner may be sifted, as needed.

### Measurements of Physical Properties

The methods for measuring the physical properties of the toner and its materials will be described below.

### Measurement of Weight Average Particle Size (D4) of Toner Particles

The weight average particle size (D4) of the toner particles is determined as below. A particle counter with a 100 m-aperture tube, based on an aperture impedance method, “CDA-1000X” (manufactured by Sysmex Corporation) is used as the measurement apparatus. For setting the measurement conditions and analyzing the measured data, dedicated software “CDA-1000X” (provided by Sysmex Corporation) is used.

The aqueous electrolyte solution used for the measurement can be, for example, “CELLPACK” (manufactured by Sysmex Corporation).

Before measurement and analysis, the dedicated software is set up as below.

On the “Measurement Conditions Settings” (translation from Japanese) screen of the dedicated software, the total count is set to 50,000, the number of repeat measurements is set to 1, and the measurement mode is set to Total Count (unlimited).

Specifically, the measurement is performed according to the following procedure:

(1) Place about 150 mL of the aqueous electrolyte solution in the dedicated round-bottom glass beaker, and stir the solution with a stirring blade at 500 rpm with the beaker set on a sample stand. Then, click “Blank Check Measurement” (translation from Japanese) in the dedicated software to start the measurement and ensure that the count is less than 500. If the count is 500 or more, repeat the cleaning of the beaker and the aperture.

(2) Place about 30 mL of the aqueous electrolyte solution in a 100 mL flat-bottom glass beaker. Add about 0.3 mL of dispersant, “CONTAMINON N” diluted to about 3 times its mass with ion-exchanged water to this solution. CONTAMINON N is a 10 mass % aqueous solution of a pH 7 neutral detergent for precision measurement instruments, containing a nonionic surfactant, an anionic surfactant, and an organic builder, produced by FUJIFILM Wako Pure Chemical Corporation.

(3) Prepare an ultrasonic dispersion system, Tetra 150 (manufactured by Nikkaki Bios), that has an electric power of 120 W and contains two oscillators with an oscillation frequency of 50 kHz and a phase shift of 180°. Place about 3.3 L of ion-exchanged water in the water tank of the ultrasonic dispersion system, and then add about 2 mL of CONTAMINON N into the water tank.

(4) Set the beaker of the above (2) in the beaker securing hole of the ultrasonic dispersion system, and start the ultrasonic dispersion system. Then, adjust the height of the beaker so as to maximize the resonance at the level of the aqueous electrolyte solution in the beaker.

(5) While applying ultrasonic waves to the aqueous electrolyte solution in the beaker of (4), add about 10 mg of toner little by little and disperse the toner. Continue ultrasonic dispersion for another 60 s.

For the ultrasonic dispersion, appropriately adjust the water temperature in the water tank to 10° C. to 40° C.

(6) Drop the aqueous electrolyte solution of (5), in which the toner is dispersed, using a pipette, into the round-bottom beaker of the above (1) set in the sample stand to adjust the measurement concentration to about 6%. Then, perform measurement until the number of measured particles reaches 50,000.

(7) Analyze the measurement data with the dedicated software, and calculate the weight average particle size (D4).

### Determination of Number Average Particle Size of Strontium Titanate Fine Particles

The number average particle size of the strontium titanate is determined using an image of the inorganic fine particles (or mixture with the pigment, when the toner contains a pigment) separated from the toner, taken with a Hitachi Ultra-High Resolution Field Emission Scanning Electron Microscope S-4800 (manufactured by Hitachi High-Tech Corporation). The image taking conditions using S-4800 are as follows:

### (1) Sample Preparation

Apply a thin layer of an electrically conductive paste onto a sample stage (15 mm×6 mm aluminum sample stage), and blow inorganic fine particles separated from the toner on the thin layer. Blow air to remove the excess of the inorganic fine particles from the sample stage, and sufficiently dry the material on the sample stage. Set the sample stage in the sample holder, and adjust the height of the sample stage to 36 mm with a sample height gauge.

### (2) Setup of S-4800 Observation Conditions

Determine the number average particle size using an image obtained through observation of the S-4800 backscattered electron image. Fill the anti-contamination trap attached to the S-4800 housing with liquid nitrogen until the nitrogen overflows, and leave the trap for 30 minutes. Start “PC-SEM” of S-4800 for flushing (cleaning of the FE chip, which is the electron source). Click the acceleration voltage display section in the control panel on the screen and press the [Flushing] button to open the flushing execution dialog. Ensure that the flushing intensity is 2, and execute flushing. Ensure that the emission current is 20 μA to 40 μA after flushing. Insert the sample holder into the sample chamber of the S-4800 housing. Press the [Origin] on the control panel to move the sample holder to the observation position.

Click the acceleration voltage display section, open the HV setting dialog, and set the acceleration voltage to [1.1 kV] and emission current to [20 μA]. Set the signal selection to [SE] in the [Basic] tab of the operation panel, select [Upper (U)] and [+BSE] for the SE detector, and select [L.A. 100] in the selection box to the right of [+BSE], thus setting the mode to observe backscattered electron images. Similarly, in the [Basic] tab of the operation panel, set the probe current to [Normal] in the electron-optical system condition block, the focus mode to [UHR], and WD to [4.5 mm]. Press the [ON] button in the acceleration voltage display section on the control panel to apply an acceleration voltage.

### (3) Focusing

Turn the focus knob [COARSE] on the operational panel and adjust the aperture alignment until reasonably in focus. Click [Align] on the control panel to display the alignment dialog, and then select [Beam]. Turn the STIGMA/ALIGNMENT knob (X, Y) on the operational panel to move the displayed beam to the center of the concentric circle. Select [Aperture] and turn the STIGMA/ALIGNMENT knob (X, Y) one at a time until the image movement is stopped or minimized. Close the aperture dialog, and focus the apparatus using the autofocus function. Then, set the magnification to 80,000 (80 k) times, adjust the focus using the focus knob and the STIGMA/ALIGNMENT knob as described above, and focus the apparatus again using the autofocus function. Repeat this operation for focusing. If the inclination angle of the observation surface is large, the measurement accuracy of the number average particle size tends to decrease. To minimize the surface inclination, a sample that allows focusing on the entire observation surface simultaneously when the focus is adjusted is selected for analysis.

### (4) Image Saving

Adjust the brightness in the ABC mode, take photos at 640×480 pixels, and save the photos. Perform the following image analysis using these image files. In order to ensure a desired number of particles to determine the number average particle size through the measurement of the particle size of at least 500 inorganic fine particles, take photos at a plurality of positions so as not to capture the same inorganic fine particles to obtain images.

### (5) Image Analysis

Measure the particle size of at least 500 inorganic fine particles, and determine the number average particle size as follows. Binarize the images obtained as above using the image analysis software Image-Pro Plus ver. 5.0, and calculate the number average particle size.

In the case of contamination of the inorganic fine particles separated from the toner with pigment or the like, the sample is subjected to elemental analysis using an energy dispersive X-ray analyzer (EDS) or sorting based on particle size and shape to remove particles other than the inorganic fine particles before measurement.

### Measurement of Work Function

The work function can be measured with a surface analyzer, AC-3, manufactured by Riken Keiki Co., Ltd. The UV source can be a D2 lamp, set at an irradiation light intensity of 500 nW and a spot size of 2 mm×5 mm. The sample is irradiated in an energy scanning range of 4.00 eV to 7.00 eV at intervals of 0.05 eV for 10 s/point to detect photoelectrons emitted from the sample surface. The work function is measured with a repeatability (standard deviation) of 0.02 eV. For measuring powder, a powder measurement cell is used.

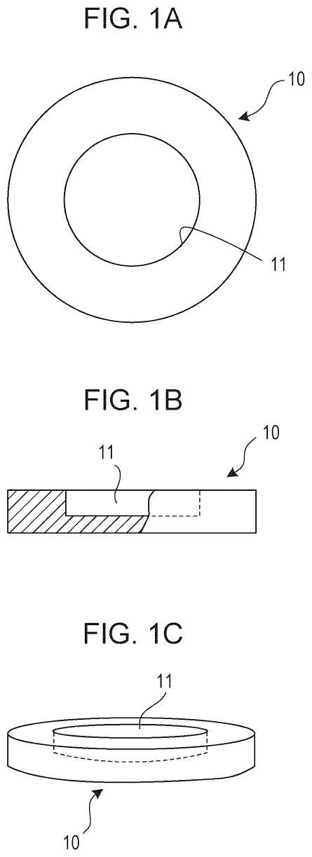

FIGS. 1A to 1C are schematic diagrams of a powder measurement cell. FIG. 1A is a plan view of a cell 10, FIG. 1B is a partially cut-away sectional view of the cell, and FIG. 1C is a perspective view. The cell 10 is a stainless-steel disk with a diameter of 30 mm and a height of 5 mm, having a sample-holding recess 11 with a diameter of 15 mm and a depth of 3 mm in the center. The sample is placed in the recess 11 using a weighing spoon without tamping the sample down, and the surface of the sample is leveled with a knife edge. Then, the measurement cell is fixed in place on the sample stage for measurement.

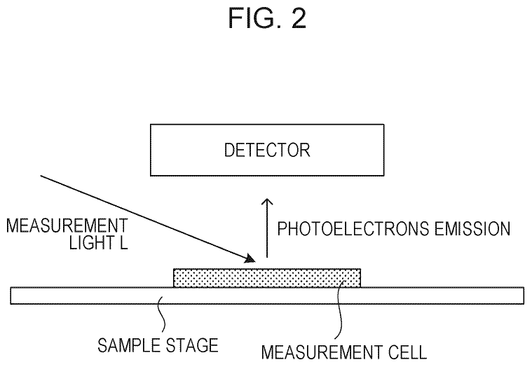

In this instance, the measurement cell is fixed in a specific position on the sample stage so that the surface to be irradiated is smooth in the direction of emitted measurement light L, as depicted in FIG. 2. Thus, the detector (photomultiplier tube) efficiently detects emitted photoelectrons. When the excitation energy of monochromatic light scans from low to high in this surface analysis, photon emission begins at a certain energy value (eV). This energy value refers to the work function (eV). To ensure data repeatability, the sample is allowed to stand at 23° C. and 60% RH for 24 hours before measurement.

### Features Included in Embodiments According to the Disclosure

The present disclosure includes the following features.

Feature 1 A toner including toner particles individually containing a binder resin and a coloring agent, and strontium titanate fine particles. The strontium titanate fine particles have a work function of 5.65 eV to 7.00 eV.

Feature 2 The toner according to Feature 1, wherein the strontium titanate fine particles are produced in a wet process.

Feature 3 The toner according to Feature 1 or 2, wherein the strontium titanate fine particles are treated with a silane coupling agent and silicone oil.

Feature 4 The toner according to Feature 3, wherein the silane coupling agent is an alkyltrialkoxysilane containing an alkyl group with 3 to 6 carbon atoms.

Feature 5 The toner according to Feature 3, wherein the silicone oil has a viscosity of 1.0×10⁻⁷ m²/s to 0.1 m²/s at 25° C.

Feature 6 The toner according to any one of Features 1 to 5, wherein the strontium titanate fine particles have a number average particle size of 5 nm to 50 nm.

Feature 7 The toner according to any one of Features 1 to 6, wherein the amount of the strontium titanate fine particles in the toner is 0.1% to 5.0% by mass.

Feature 8 The toner according to any one of Features 1 to 7, wherein the toner particles individually contain the strontium titanate fine particles.

### Examples

In the following Examples, “part(s)” is on a mass basis.

### Preparation Example of Binder Resin L

Polyoxypropylene (2.2)-2,2-bis(4-hydroxyphenyl)propane: 72.0 parts (0.20 parts by mole, 100.0 mol % relative to the total number of moles of polyhydric alcohols)
Terephthalic acid: 28.0 parts (0.17 parts by mole, 100.0 mol % relative to the total number of moles of polyvalent carboxylic acids)
Tin 2-ethylhexanoate (esterification catalyst): 0.5 parts

The above materials were weighed out and placed in a reaction tank equipped with a cooling tube, a stirrer, a nitrogen inlet, and a thermocouple.

After the reaction tank was purged with nitrogen gas, the contents in the tank were gradually heated with stirring and allowed to react with stirring at 200° C. for 4 hours.

The pressure in the reaction tank was reduced to 8.3 kPa and maintained at this pressure for 1 hour, and then returned to atmospheric pressure after cooling to 180° C.
Trimellitic anhydride: 3 parts (0.01 parts by mole, 4.0 mol % relative to the total number of moles of polyvalent carboxylic acids)
tert-Butylcatechol (polymerization inhibitor): 0.1 parts

Subsequently, the above materials were added into the reaction tank, and the mixture was allowed to react for 1 hour with the pressure in the tank reduced to 8.3 kPa and the temperature maintained at 180° C. After ensuring that the softening point measured according to ASTM D36-86 reached 90° C., the reaction was terminated by lowering the temperature, thus producing binder resin L.

### Preparation Example of Binder Resin H

Polyoxypropylene (2.2)-2,2-bis(4-hydroxyphenyl)propane: 72.3 parts (0.20 parts by mole, 100.0 mol % relative to the total number of moles of polyhydric alcohols)
Terephthalic acid: 18.3 parts (0.11 parts by mole, 65.0 mol % relative to the total number of moles of polyvalent carboxylic acids)
Fumaric acid: 2.9 parts (0.03 parts by mole, 15.0 mol % relative to the total number of moles of polyvalent carboxylic acids)
Tin 2-ethylhexanoate (esterification catalyst): 0.5 parts

The above materials were weighed out and placed in a reaction tank equipped with a cooling tube, a stirrer, a nitrogen inlet, and a thermocouple.

After the reaction tank was purged with nitrogen gas, the contents in the tank were gradually heated with stirring and allowed to react with stirring at 200° C. for 2 hours.

The pressure in the reaction tank was reduced to 8.3 kPa and maintained at this pressure for 1 hour, and then returned to atmospheric pressure after cooling to 180° C.
Trimellitic anhydride: 6.5 parts (0.03 parts by mole, 20.0 mol % relative to the total number of moles of polyvalent carboxylic acids)
tert-Butylcatechol (polymerization inhibitor): 0.1 parts

Subsequently, the above materials were added into the reaction tank, and the mixture was allowed to react for 15 hours with the pressure in the tank reduced to 8.3 kPa and the temperature maintained at 160° C. After ensuring that the softening point measured according to ASTM D36-86 reached 137° C., the reaction was terminated by lowering the temperature, thus producing binder resin H.

### Production Example of Inorganic Fine Particles 1

Metatitanic acid produced by a sulfate process was subjected to de-ironing and bleaching. The resulting metatitanic acid was adjusted to a pH of 9.0 with 3 mol/L sodium hydroxide aqueous solution and then desulfurized, followed by neutralization to pH 5.6 with 5 mol/L hydrochloric acid, filtration, and rinsing with water. Water was added to the rinsed cake to form a slurry with a concentration of 1.90 mol/L in terms of TiO₂. Then, the pH was adjusted to 1.4 with hydrochloric acid to peptize the slurry.

Then, 1.90 mol (in terms of TiO₂) of the peptized metatitanic acid was placed in a 3 L reaction vessel. Strontium chloride (2.185 mol) in a state of aqueous solution was added to the peptized metatitanic acid slurry in a SrO/TiO₂ mole ratio of 1.15, followed by adjusting the TiO₂ concentration to 1.039 mol/L. Subsequently, the mixture was heated to 90° C. with stirring, and 440 mL of 10 mol/L sodium hydroxide aqueous solution was added to the mixture over a period of 40 minutes. Then, stirring was continued at 95° C. for 30 minutes, and the reaction was terminated by rapid cooling in ice water.

The resulting slurry was cooled to 70° C., and 12 mol/L hydrochloric acid was added to the slurry until the pH reached 5.0, followed by stirring for 1 hour and decantation of the resulting sediment. Then, the slurry containing the resulting sediment was adjusted to 40° C. and then to pH 2.5 with hydrochloric acid, and isobutyltrimethoxysilane was added in a proportion of 4.0% by mass relative to the solids, followed by stirring for 10 hours. Subsequently, dimethyl silicone oil with a viscosity of 1.0×10⁻³ m²/s was added in a proportion of 4.0% by mass relative to the solids, and the mixture was stirred for 10 hours. After 5 mol/L sodium hydroxide aqueous solution was added to adjust the pH to 6.5, followed by stirring for 1 hour, the resulting substance was filtered and washed. The resulting cake was dried at 120° C. in the air for 8 hours to yield strontium titanate fine particles as inorganic fine particles 1. The work function of the strontium titanate fine particles was 5.78 eV. The physical properties are presented in Table 1.

### Production Example of Inorganic Fine Particles 2 to 12

Strontium titanate fine particles as inorganic fine particles 2 to 12 were produced in the same manner as in the production example of inorganic fine particles 1 except that the particle size, the silane coupling agent, and the silicone oil were changed as presented in Table 1. The physical properties are presented in Table 1.

### Production Example of Inorganic Fine Particles 13

Strontium carbonate (600 g) and titanium oxide (350 g) were wet-mixed in a ball mill for 8 hours, followed by filtration and drying. The resulting mixture was compacted at a pressure of 10 kg/cm² and sintered at 1200° C. for 7 hours. The sintered compact was mechanically pulverized into strontium titanate fine particles as inorganic fine particles 13, whose primary particles through sintering had an average particle size of 60 nm. The work function was 5.66 eV. The physical properties are presented in Table 1.

### Production Example of Inorganic Fine Particles 14

Strontium carbonate (600 g) and titanium oxide (350 g) were wet-mixed in a ball mill for 8 hours, followed by filtration and drying. The resulting mixture was compacted at a pressure of 10 kg/cm² and sintered at 1200° C. for 7 hours. The sintered compact was mechanically pulverized into strontium titanate fine particles, whose primary particles through sintering had an average particle size of 60 nm. A 50 g portion of the strontium titanate fine particles was dispersed in 500 mL of ion-exchanged water. The resulting strontium titanate fine particle dispersion liquid was adjusted to a pH of 3 to 4 by adding 5 N hydrochloric acid. To the pH-adjusted strontium titanate fine particle dispersion liquid, methyltriethoxysilane was added in a proportion of 4.0% by mass relative to the solids, and the mixture was stirred for 10 hours. The resulting solution was removed into a 1 L separable flask, and the contents in the flask were allowed to react at 70° C. for 30 minutes. After 5 N sodium hydroxide aqueous solution was added to adjust the pH to 6.5, followed by stirring for 1 hour, the resulting substance was filtered and washed. The resulting cake was dried at 120° C. in the air for 8 hours to yield strontium titanate fine particles as inorganic fine particles 14. The work function was 5.60 eV. The physical properties are presented in Table 1.

### Production Example of Inorganic Fine Particles 15

In 500 mL of ion-exchanged water, 50 g of fumed silica (source of silica fine particles) with a number average particle size of 60 nm was dispersed. The resulting silica particle dispersion liquid was adjusted to a pH of 3 to 4 by adding 5 mol/L hydrochloric acid. To the pH-adjusted silica particle dispersion liquid, methyltriethoxysilane was added in a proportion of 4.0% by mass relative to the solids, and the mixture was stirred for 10 hours. Then, dimethyl silicone oil with a viscosity of 0.2 m²/s was added in a proportion of 4.0% by mass relative to the solids, and the mixture was stirred for 10 hours. After 5 mol/L sodium hydroxide aqueous solution was added to adjust the pH to 6.5, followed by stirring for 1 hour, the resulting substance was filtered and washed. The resulting cake was dried at 120° C. in the air for 8 hours to yield silica fine particles as inorganic fine particles 15. The work function was 5.50 eV. The physical properties are presented in Table 1.

### Production Example of Inorganic Fine Particles 16

In 500 mL of ion-exchanged water, 50 g of titanium oxide particles (source of titanium oxide fine particles) with a number average particle size of 60 nm was dispersed. The resulting titanium oxide particle dispersion liquid was adjusted to a pH of 3 to 4 by adding 5 mol/L hydrochloric acid. To the pH-adjusted titanium oxide dispersion liquid, methyltriethoxysilane was added in a proportion of 4.0% by mass relative to the solids, and the mixture was stirred for 10 hours. Then, dimethyl silicone oil with a viscosity of 0.2 m²/s was added in a proportion of 4.0% by mass relative to the solids, and the mixture was stirred for 10 hours. After 5 mol/L sodium hydroxide aqueous solution was added to adjust the pH to 6.5, followed by stirring for 1 hour, the resulting substance was filtered and washed. The resulting cake was dried at 120° C. in the air for 8 hours to yield titanium oxide fine particles as inorganic fine particles 16. The work function was 5.45 eV. The physical properties are presented in Table 1.

TABLE 1

| | | | | Number | | |
|---|---|---|---|---|---|---|
| | | Work | | average | | Silicone oil |
| Inorganic fine | Base | function | Production | particle size | Alkyl group of coupling | viscosity |
| particles | material | (eV) | process | (nm) | agent | (m²/s) |
| Inorganic fine | Strontium | 5.78 | Wet | 35 | Isobutyltrimethoxysilane | 1.0 × 10⁻³ |
| particles 1 | titanate | | | | | |
| Inorganic fine | Strontium | 5.77 | Wet | 35 | Isobutyltrimethoxysilane | 2.5 × 10⁻⁴ |
| particles 2 | titanate | | | | | |
| Inorganic fine | Strontium | 5.77 | Wet | 35 | Isobutyltrimethoxysilane | 5.0 × 10⁻² |
| particles 3 | titanate | | | | | |
| Inorganic fine | Strontium | 5.75 | Wet | 35 | Isobutyltrimethoxysilane | 0.2 |
| particles 4 | titanate | | | | | |
| Inorganic fine | Strontium | 5.74 | Wet | 10 | Isobutyltrimethoxysilane | 0.2 |
| particles 5 | titanate | | | | | |
| Inorganic fine | Strontium | 5.74 | Wet | 40 | Isobutyltrimethoxysilane | 0.2 |
| particles 6 | titanate | | | | | |
| Inorganic fine | Strontium | 5.72 | Wet | 60 | Isobutyltrimethoxysilane | 0.2 |
| particles 7 | titanate | | | | | |
| Inorganic fine | Strontium | 5.70 | Wet | 60 | n-Propyltrimethoxysilane | 0.2 |
| particles 8 | titanate | | | | | |
| Inorganic fine | Strontium | 5.70 | Wet | 60 | n-Hexyltrimethoxysilane | 0.2 |
| particles 9 | titanate | | | | | |
| Inorganic fine | Strontium | 5.69 | Wet | 60 | Ethyltrimethoxysilane | 0.2 |
| particles 10 | titanate | | | | | |
| Inorganic fine | Strontium | 5.69 | Wet | 60 | Ethyltrimethoxysilane | — |
| particles 11 | titanate | | | | | |
| Inorganic fine | Strontium | 5.67 | Wet | 60 | — | — |
| particles 12 | titanate | | | | | |
| Inorganic fine | Strontium | 5.66 | Sintering | 60 | — | — |
| particles 13 | titanate | | | | | |
| Inorganic fine | Strontium | 5.60 | Sintering | 60 | Methyltriethoxysilane | — |
| particles 14 | titanate | | | | | |
| Inorganic fine | Silica | 5.50 | Sintering | 60 | Methyltriethoxysilane | 0.2 |
| particles 15 | | | | | | |
| Inorganic fine | Titanium | 5.45 | Sintering | 60 | Methyltriethoxysilane | 0.2 |
| particles 16 | oxide | | | | | |

### Production Example of Toner 1

Binder resin L: 70 parts
Binder resin H: 30 parts
Fischer-Tropsch wax (hydrocarbon wax, maximum endothermic peak temperature: 90′Q): 5 parts
C.I. Pigment Blue 15:3:5 parts
Inorganic fine particles 1: 3 parts

First, the above materials were mixed using a Henschel mixer, and then, the mixture was melted and kneaded with a twin-screw extruder. In this operation, the temperature of the kneaded resin is set to 140° C. by adjusting the residence time. The kneaded product was cooled, roughly crushed with a hammer mill, and pulverized with a turbo mill. The resulting fine particles were classified with a multi-classification classifier using the Coanda effect (Elbow-Jet (trade name), manufactured by Nittetsu Mining Co., Ltd.) to obtain toner particles with a weight average particle size (D4) of 6.5 m.

The following materials were added to 100 parts of the toner particles:
Hydrophobic silica (BET specific surface area: 200 m²/g): 0.5 parts; and
Inorganic fine particles 1: 0.5 parts

These materials were mixed using a Henschel mixer (FM-75, manufactured by Nippon Coke & Engineering Co., Ltd.) at a rotational speed of 30 s⁻¹ for 10 minutes. Thus, the toner particles were subjected to external addition. Then, the toner with external additives was sifted through a mesh with 150 m openings to yield toner 1. Table 2 presents the composition of each toner.

### Production Examples of Toners 2 to 20

Toners were produced in the same manner as toner 1, except that the formulation was changed as presented in Table 2.

TABLE 2

| | | | Inorganic fine |
|---|---|---|---|
| | | Amount | particle content |
| Toner | | added | of toner particle |
| No. | Inorganic fine particles | (part(s)) | (parts) |
| Toner 1 | Inorganic fine particles 1 | 0.5 | 3.0 |
| Toner 2 | Inorganic fine particles 1 | 0.5 | 0 |
| Toner 3 | Inorganic fine particles 1 | 0.15 | 0 |
| Toner 4 | Inorganic fine particles 1 | 4.1 | 0 |
| Toner 5 | Inorganic fine particles 1 | 5.2 | 0 |
| Toner 6 | Inorganic fine particles 2 | 5.2 | 0 |
| Toner 7 | Inorganic fine particles 3 | 5.2 | 0 |
| Toner 8 | Inorganic fine particles 4 | 5.2 | 0 |
| Toner 9 | Inorganic fine particles 5 | 5.2 | 0 |
| Toner 10 | Inorganic fine particles 6 | 5.2 | 0 |
| Toner 11 | Inorganic fine particles 7 | 5.2 | 0 |
| Toner 12 | Inorganic fine particles 8 | 5.2 | 0 |
| Toner 13 | Inorganic fine particles 9 | 5.2 | 0 |
| Toner 14 | Inorganic fine particles 10 | 5.2 | 0 |
| Toner 15 | Inorganic fine particles 11 | 5.2 | 0 |
| Toner 16 | Inorganic fine particles 12 | 5.2 | 0 |
| Toner 17 | Inorganic fine particles 13 | 5.2 | 0 |
| Toner 18 | Inorganic fine particles 14 | 5.2 | 0 |
| Toner 19 | Inorganic fine particles 15 | 5.2 | 0 |
| Toner 20 | Inorganic fine particles 16 | 5.2 | 0 |

### Production Example of Magnetic Core Particles 1

### Step 1 (Weighing and Mixing)

Fe₂O₃: 62.7 parts
MnCO₃: 29.5 parts
Mg(OH)₂: 6.8 parts
SrCO₃: 1.0 part

The above ferrite materials were weighed in the above composition ratios. Then, the materials were mixed and pulverized for 5 hours in a wet vibrating mill using ⅛ inch-diameter stainless beads.

### Step 2 (Calcination)

The pulverized mixture was formed into pellets with about 1 mm square using a roller compactor. The pellets were sifted through a vibrating sieve with 3 mm openings to remove coarse powder and further through a vibrating sieve with 0.5 mm openings to remove fine powder, and then fired in a nitrogen atmosphere (0.01 vol % oxygen concentration) at 1000° C. for 4 hours using a burner furnace, thus producing calcined ferrite. The resulting calcined ferrite is represented by the following compositional formula:

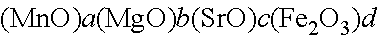

wherein a=0.257, b=0.117, c=0.007, and d=0.393.

### Step 3 (Pulverization)

The calcined ferrite was crushed to a particle size of about 0.3 mm with a crusher. Then, 30 parts of water was added to 100 parts of calcined ferrite, and the ferrite was pulverized for 1 hour in a wet ball mill using ⅛ inch-diameter zirconia beads. The resulting slurry was further pulverized in a wet ball mill using 1/16 inch-diameter alumina beads for 4 hours to obtain a ferrite slurry (pulverized calcined ferrite).

### Step 4 (Particle Formation)

To 100 parts of the ferrite slurry, 1.0 part of ammonium polycarboxylate as a dispersant and 2.0 parts of polyvinyl alcohol as a binder were added. The mixture was formed into spherical particles using a spray dryer (manufactured by Ohkawara Kakohki). After adjusting the particle size of the resulting particles, the organic components of the dispersant and binder were removed by heating at 650° C. for 2 hours using a rotary kiln.

### Step 5 (Firing)

The particles were fired at temperatures raised from room temperature to 1300° C. over 2 hours and then at 1150° C. for 4 hours, in an electric furnace in a nitrogen atmosphere (containing 1.00 vol % of oxygen). Then, the temperature was reduced to 60° C. over a period of 4 hours, and the nitrogen atmosphere was replaced with atmospheric air. The particles were removed from the furnace at 40° C. or lower.

### Step 6 (Screening)

After crushing the aggregates of the particles, coarse particles were removed through a sieve with 250 m openings to obtain magnetic core particles 1 with a median diameter (D50) of 37.0 m based on the volume distribution.

### Preparation of Coating Resin 1

Cyclohexyl methacrylate: 26.8% by mass
Methyl methacrylate: 0.2% by mass
Methyl methacrylate macromonomer: 8.4% by mass
(macromonomer with a methacryloyl group at an end, having a weight average molecular weight of 5000)
Toluene: 31.3% by mass
Methyl ethyl ketone: 31.3% by mass
Azobisisobutyronitrile: 2.0% by mass

Cyclohexyl methacrylate (monomer), methyl methacrylate (monomer), methyl methacrylate macromonomer, toluene, and methyl ethyl ketone of the above materials were placed in a four-neck separable flask equipped with a reflux condenser, a thermometer, a nitrogen inlet, and a stirrer. Nitrogen gas was then introduced to purge the system. After heating the system to 80° C., azobisisobutyronitrile was added, and the mixture was refluxed for 5 hours for polymerization. Hexane was added to the resulting reaction product to precipitate the copolymer. The precipitate was collected by filtration and vacuum dried to yield coating resin 1. In 40 parts of toluene and 30 parts of methyl ethyl ketone, 30 parts of the resulting coating resin 1 was dissolved to obtain polymer solution 1 (30 mass % solids).

### Preparation of Coating Resin Solution 1

Polymer solution 1 (30% resin solids): 33.3% by mass
Toluene: 66.4% by mass
Carbon black (Regal 330, produced by Cabot): 0.3% by mass
(primary particle size: 25 nm, nitrogen adsorption specific surface area: 94 m²/g, DBP absorption: 75 mL/100 g)

The above materials were dispersed in each other for 1 hour in a paint shaker using zirconia beads with a diameter of 0.5 mm. The resulting dispersion liquid was filtered through a 5.0 m membrane filter to yield coating resin solution 1.

### Production Example of Magnetic Carrier 1

### Resin Coating Step

Coating resin solution 1 was introduced to a vacuum degassing kneader maintained at room temperature in a proportion of 2.5 parts in terms of resin component relative to 100 parts of magnetic core particles 1. Then, the materials were stirred at a rotational speed of 30 rpm for 15 minutes. After the solvent was evaporated to a certain extent (80% by mass) or more, the mixture was heated to 80° C. with mixing under reduced pressure, and toluene was removed over a period of 2 hours, followed by cooling. The resulting magnetic carrier was screened for low-magnetic-force particles by magnetic separation. After sieving through a sieve with 70 m openings, the particles were classified with an air classifier to yield magnetic carrier 1 with a median diameter (D50) of 38.2 m based on the volume distribution.

### Production Example of Two-Component Developer 1

Two-component developer 1 was produced by adding 8.0 parts of toner 1 to 92.0 parts of magnetic carrier 1 and mixing the materials with a V-blender (V-20, manufactured by Seishin Enterprise).

### Production Examples of Two-Component Developers 2 to 20

Two-component developers 2 to 20 were produced in the same manner as in the production example of two-component developer 1, except that toners 2 to 20 were used, respectively.

### Example 1

For evaluation, two-component developer 1 was used.

A full color POD machine, imagePRESS V1350, manufactured by Canon, was modified to a process speed of 650 mm/s as the image forming apparatus, and two-component developer 1 was placed into the developing unit in the cyan station. The DC voltage VDC of the developer bearing member, the charge voltage VD of the electrostatic latent image bearing member, and the laser power were adjusted so as to achieve a desired toner deposition rate for the evaluations described later. The key point of the modification is that the process speed can be set freely. Copy paper sheets GF-C081 (A4, 81.0 g/m² basis weight, available from Canon Marketing Japan) were used for evaluations.

Evaluations were conducted using the following test methods, and the results are presented in Tables 3-1 and 3-2.

### Evaluation 1: Fogging Test in NN Environment, 10,000 Sheets

In an N/N (23° C., 50%) environment, the development contrast of the main unit was adjusted so that the reflection density of a solid image output would be 1.50 when measured with an optical densitometer. Under these conditions, 10,000 copies of a cyan single-color image pattern, covering 40% of each sheet, were continuously output. Then, three copies of a white solid image covering the entire A3 paper sheet were output. The image on the third sheet was evaluated. The average reflectance Dr (%) of six points in an unprinted paper sheet and the average reflectance Ds (%) of six points in the printed paper sheet were measured with a reflectometer, model TC-6DS (manufactured by Tokyo Denshoku), and the degree (%) of fogging was determined. As the chargeability increases, unintended scattering decreases, thereby reducing fogging.

$$Degree of fogging ( \% ) = Dr ( \% ) - Ds ( \% )$$

### Criteria:

A: Degree of fogging was less than 0.3% (very excellent).

B: Degree of fogging was 0.3% or more and less than 0.6% (excellent).

C: Degree of fogging was 0.6% or more and less than 0.9% (good).

D: Degree of fogging was 0.9% or more and less than 1.2% (acceptable according to the present disclosure).

E: Degree of fogging was 1.2% or more (not acceptable according to the present disclosure).

### Evaluation 2: Density Test in NN Environment, 10,000 Sheets

In an N/N (23° C., 50%) environment, the main unit was adjusted so that the reflection density of a solid image output would be a specific value when measured with an optical densitometer. A cyan single-color image pattern, covering 5% of each sheet, was continuously output on 10,000 sheets. Then, three copies of a solid image covering the entire A4 paper sheet were output. The image on the third sheet was evaluated. Image density was measured at 5 points, and the average was calculated. The image density was measured with a spectroscopic densitometer 500 series (manufactured by X-Rite), and the results were evaluated according to the following criteria.

### Criteria:

A: Density was 1.40 or more (very excellent).

B: Density was 1.35 or more and less than 1.40 (excellent).

C: Density was 1.30 or more and less than 1.35 (good).

D: Density was 1.25 or more and less than 1.30 (acceptable according to the present disclosure).

E: Density was less than 1.25 (not acceptable according to the present disclosure).

### Evaluation 3: Thin Line Reproductivity (Transfer Void) Test in NN Environment, 10,000 Sheets

In an N/N (23° C., 50%) environment, the development contrast of the main unit was adjusted so that the reflection density of a solid image output would be 1.50 when measured with an optical densitometer. Under these conditions, 10,000 copies of a cyan single-color image pattern, covering 1% of each sheet, were continuously output, and then, a 500 m horizontal line pattern was output on a sheet. The thin line was magnified with a digital microscope, and the percentage of the area of voids within the magnified line width was calculated as the void ratio through a binarization process. For example, a void ratio of 50% indicates that 50% of the white background area is visible within the line width. The obtained void ratio was evaluated according to the following criteria.

### Criteria:

A: Void ratio was less than 1% (very excellent).

B: Void ratio was 1% or more and less than 5% (excellent).

C: Void ratio was 5% or more and less than 10% (good).

D: Void ratio was 10% or more and less than 20% (acceptable according to the present disclosure).

E: Void ratio was 20% or more (not acceptable according to the present disclosure).

### Evaluation 4: Image Uniformity (Contamination by Component Members) Test in NN Environment, 10,000 Sheets

In an N/N (23° C., 50%) environment, the development contrast of the main unit was adjusted so that the reflection density of a solid image output would be 1.50 when measured with an optical densitometer. Under these conditions, 10,000 copies of a cyan single-color image pattern, covering 40% of each sheet, were continuously output. Then, three copies of a halftone image covering the entire A3 paper sheet were output. The image on the third sheet was evaluated. Image density was measured at 5 points, and the difference between the highest and lowest values was calculated. The image density was measured with a spectroscopic densitometer 500 series (manufactured by X-Rite), and the results were evaluated according to the following criteria. Contamination by component members, such as the charging roller, degrades image uniformity.

### Criteria:

A: Density difference was less than 0.03 (very excellent).

B: Density difference was 0.03 or more and less than 0.06 (excellent).

C: Density difference was 0.06 or more and less than 0.09 (good).

D: Density difference was 0.09 or more and less than 0.12 (acceptable according to the present disclosure).

E: Density difference was 0.12 or more (not acceptable according to the present disclosure).

### Evaluation 5: Fogging Through Endurance Operation in NN Environment

In an N/N (23° C., 50%) environment, the development contrast of the main unit was adjusted so that the reflection density of a solid image output would be 1.50 when measured with an optical densitometer. Under these conditions, 100,000 copies of a cyan single-color image pattern, covering 40% of each sheet, were continuously output. Then, three copies of a white solid image covering the entire A3 paper sheet were output. The image on the third sheet was evaluated. The average reflectance Dr (%) of six points in an unprinted paper sheet and the average reflectance Ds (%) of six points in the printed paper sheet were measured with a reflectometer, model TC-6DS (manufactured by Tokyo Denshoku), and the degree (%) of fogging was determined as in Evaluation 1.

### Criteria:

A: Degree of fogging was less than 0.3% (very excellent).

B: Degree of fogging was 0.3% or more and less than 0.6% (excellent).

C: Degree of fogging was 0.6% or more and less than 0.9% (good).

D: Degree of fogging was 0.9% or more and less than 1.2% (acceptable according to the present disclosure).

E: Degree of fogging was 1.2% or more (not acceptable according to the present disclosure).

Evaluation 6: Density after Endurance Operation in NN Environment

In an N/N (23° C., 50%) environment, the main unit was adjusted so that the reflection density of a solid image output would be a specific value when measured with an optical densitometer. A cyan single-color image pattern, covering 5% of each sheet, was continuously output on 100,000 sheets. Then, three copies of a solid image covering the entire A4 paper sheet were output. The image on the third sheet was evaluated. Image density was measured at 5 points, and the average was calculated. The image density was measured with a spectroscopic densitometer 500 series (manufactured by X-Rite), and the results were evaluated according to the following criteria.

### Criteria:

A: Density was 1.40 or more (very excellent).

B: Density was 1.35 or more and less than 1.40 (excellent).

C: Density was 1.30 or more and less than 1.35 (good).

D: Density was 1.25 or more and less than 1.30 (acceptable according to the present disclosure).

E: Density was less than 1.25 (not acceptable according to the present disclosure).

Evaluation 7: Fogging after Endurance Operation in NL Environment

In an N/L (23° C., 5%) environment, the development contrast of the main unit was adjusted so that the reflection density of a solid image output would be 1.50 when measured with an optical densitometer. Under these conditions, 100,000 copies of a cyan single-color image pattern, covering 1% of each sheet, were continuously output. Then, three copies of a white solid image covering the entire A3 paper sheet were output. The image on the third sheet was evaluated. The average reflectance Dr (%) of six points in an unprinted paper sheet and the average reflectance Ds (%) of six points in the printed paper sheet were measured with a reflectometer, model TC-6DS (manufactured by Tokyo Denshoku), and the degree (%) of fogging was determined as in Evaluation 1.

### Criteria:

A: Degree of fogging was less than 0.3% (very excellent).

B: Degree of fogging was 0.3% or more and less than 0.6% (excellent).

C: Degree of fogging was 0.6% or more and less than 0.9% (good).

D: Degree of fogging was 0.9% or more and less than 1.2% (acceptable according to the present disclosure).

E: Degree of fogging was 1.2% or more (not acceptable according to the present disclosure).

Evaluation 8: Density after Endurance Operation in NL Environment

In an N/L (23° C., 5%) environment, the main unit was adjusted so that the reflection density of a solid image output would be a specific value when measured with an optical densitometer. A cyan single-color image pattern, covering 1% of each sheet, was continuously output on 100,000 sheets. Then, three copies of a solid image covering the entire A4 paper sheet were output. The image on the third sheet was evaluated. Image density was measured at 5 points, and the average was calculated. The image density was measured with a spectroscopic densitometer 500 series (manufactured by X-Rite), and the results were evaluated according to the following criteria.

### Criteria:

A: Density was 1.40 or more (very excellent).

B: Density was 1.35 or more and less than 1.40 (excellent).

C: Density was 1.30 or more and less than 1.35 (good).

D: Density was 1.25 or more and less than 1.30 (acceptable according to the present disclosure).

E: Density was less than 1.25 (not acceptable according to the present disclosure).

### Evaluation 9: Thin Line Reproductivity (Transfer Void) Test in HH Environment, 10,000 Sheets

In an H/H (30° C., 80%) environment, the development contrast of the main unit was adjusted so that the reflection density of a solid image output would be 1.50 when measured with an optical densitometer. Under these conditions, 10,000 copies of a cyan single-color image pattern, covering 40% of each sheet, were continuously output, and then, a 500 m horizontal line pattern was output on a sheet. The thin line was magnified with a digital microscope, and the percentage of the area of voids within the magnified line width was calculated as the void ratio through a binarization process. For example, a void ratio of 50% indicates that 50% of the white background area is visible within the line width. The obtained void ratio was evaluated according to the following criteria.

### Criteria:

A: Void ratio was less than 1% (very excellent).

B: Void ratio was 1% or more and less than 5% (excellent).

C: Void ratio was 5% or more and less than 10% (good).

D: Void ratio was 10% or more and less than 20% (acceptable according to the present disclosure).

E: Void ratio was 20% or more (not acceptable according to the present disclosure).

### Evaluation 10: Image Uniformity (Contamination by Component Members) Test in NL Environment, 10,000 Sheets

In an N/L (23° C., 5%) environment, the development contrast of the main unit was adjusted so that the reflection density of a solid image output would be 1.50 when measured with an optical densitometer. Under these conditions, 10,000 copies of a cyan single-color image pattern, covering 1% of each sheet, were continuously output. Then, three copies of a halftone image covering the entire A3 paper sheet were output. The image on the third sheet was evaluated. Image density was measured at 5 points, and the difference between the highest and lowest values was calculated. The image density was measured with a spectroscopic densitometer 500 series (manufactured by X-Rite), and the results were evaluated according to the following criteria. Contamination by component members, such as the charging roller, degrades image uniformity.

### Criteria:

A: Density difference was less than 0.03 (very excellent).

B: Density difference was 0.03 or more and less than 0.06 (excellent).

C: Density difference was 0.06 or more and less than 0.09 (good).

D: Density difference was 0.09 or more and less than 0.12 (acceptable according to the present disclosure).

E: Density difference was 0.12 or more (not acceptable according to the present disclosure).

### EXAMPLES 2 to 17, COMPARATIVE EXAMPLES 1 to 3

Evaluations were performed in the same manner as in Example 1, except that the two-component developer was replaced with two-component developers 2 to 20, respectively. The results are presented in Tables 3-1 and 3-2.

TABLE 3-1

| | | | | | | Evaluation 3 | | Evaluation 4 | |
|---|---|---|---|---|---|---|---|---|---|
| | | | | | | Transferability | | Contamination by | |
| | | Evaluation 1 | | Evaluation 2 | | (thin line | | component members | |
| | Two- | Fogging in NN | | Density in NN | | reproductivity) in | | (image uniformity) in | |
| | component | after 10,000 | | after 10,000 | | NN after 10,000 | | NN after 10,000 | |
| | developer | sheets output | | sheets output | | sheets output | | sheets output | |
| | No. | Rating | Value | Rating | Value | Rating | Value | Rating | Value |
| Example 1 | 1 | A | 0.01 | A | 1.45 | A | 0.20 | A | 0.01 |
| Example 2 | 2 | A | 0.01 | A | 1.44 | A | 0.20 | A | 0.01 |
| Example 3 | 3 | A | 0.02 | A | 1.43 | A | 0.20 | A | 0.01 |
| Example 4 | 4 | A | 0.02 | A | 1.42 | A | 0.20 | A | 0.01 |
| Example 5 | 5 | A | 0.02 | A | 1.42 | A | 0.30 | A | 0.02 |
| Example 6 | 6 | A | 0.02 | A | 1.42 | A | 0.40 | A | 0.02 |
| Example 7 | 7 | A | 0.02 | B | 1.39 | A | 0.60 | A | 0.02 |
| Example 8 | 8 | A | 0.02 | B | 1.39 | A | 0.70 | A | 0.02 |
| Example 9 | 9 | B | 0.04 | B | 1.39 | A | 0.90 | B | 0.03 |
| Example 10 | 10 | B | 0.04 | B | 1.38 | B | 1.10 | B | 0.03 |
| Example 11 | 11 | B | 0.05 | B | 1.37 | B | 2.20 | B | 0.03 |
| Example 12 | 12 | B | 0.05 | B | 1.36 | B | 2.30 | B | 0.03 |
| Example 13 | 13 | B | 0.05 | B | 1.36 | B | 2.90 | B | 0.04 |
| Example 14 | 14 | B | 0.05 | B | 1.36 | B | 3.10 | B | 0.04 |
| Example 15 | 15 | B | 0.05 | C | 1.33 | B | 3.50 | B | 0.05 |
| Example 16 | 16 | C | 0.07 | C | 1.32 | B | 4.80 | B | 0.05 |
| Example 17 | 17 | C | 0.07 | C | 1.32 | C | 5.50 | B | 0.05 |
| Comparative Example 1 | 18 | C | 0.07 | C | 1.31 | C | 6.80 | B | 0.05 |
| Comparative Example 2 | 19 | C | 0.07 | D | 1.29 | C | 7.20 | B | 0.05 |
| Comparative Example 3 | 20 | C | 0.08 | D | 1.29 | C | 9.50 | C | 0.07 |

TABLE 3-2

| | | | | | | | | | Evaluation 9 | | Evaluation 10 | |
|---|---|---|---|---|---|---|---|---|---|---|---|---|
| | Evaluation 5 | | Evaluation 6 | | Evaluation 7 | | Evaluation 8 | | Transferability | | Contamination by | |
| | Fogging | | Density | | Fogging | | Density | | (thin line | | component members | |
| | through | | after | | after | | after | | reproductivity) | | (image uniformity) | |
| | endurance | | endurance | | endurance | | endurance | | in HH | | in NL | |
| | operation | | operation | | operation | | operation | | after 10,000 | | after 10,000 | |
| | in NN | | in NN | | in NL | | in NL | | sheets output | | sheets output | |
| | Rating | Value | Rating | Value | Rating | Value | Rating | Value | Rating | Value | Rating | Value |
| Example 1 | A | 0.01 | A | 1.45 | A | 0.01 | A | 1.41 | A | 0.2 | A | 0.01 |
| Example 2 | A | 0.02 | A | 1.44 | A | 0.01 | B | 1.39 | A | 0.2 | A | 0.01 |
| Example 3 | A | 0.02 | A | 1.43 | B | 0.04 | B | 1.38 | A | 0.2 | A | 0.01 |
| Example 4 | B | 0.04 | A | 1.42 | B | 0.04 | B | 1.37 | A | 0.2 | A | 0.01 |
| Example 5 | B | 0.05 | B | 1.39 | B | 0.04 | B | 1.36 | A | 0.3 | A | 0.02 |
| Example 6 | B | 0.05 | B | 1.38 | B | 0.04 | C | 1.34 | A | 0.4 | A | 0.02 |
| Example 7 | B | 0.05 | B | 1.37 | B | 0.04 | C | 1.34 | A | 0.6 | B | 0.03 |
| Example 8 | B | 0.05 | B | 1.36 | C | 0.07 | C | 1.33 | A | 0.7 | B | 0.03 |
| Example 9 | B | 0.05 | C | 1.34 | C | 0.07 | C | 1.33 | A | 0.9 | B | 0.03 |
| Example 10 | B | 0.05 | C | 1.34 | C | 0.08 | C | 1.32 | B | 1.1 | B | 0.04 |
| Example 11 | C | 0.07 | C | 1.33 | C | 0.08 | C | 1.32 | B | 2.2 | B | 0.04 |
| Example 12 | C | 0.07 | C | 1.32 | D | 0.10 | C | 1.31 | B | 4.8 | B | 0.05 |
| Example 13 | C | 0.07 | C | 1.32 | D | 0.10 | C | 1.31 | C | 5.5 | B | 0.05 |
| Example 14 | C | 0.07 | C | 1.31 | D | 0.10 | D | 1.29 | C | 6.8 | B | 0.05 |
| Example 15 | C | 0.07 | D | 1.29 | D | 0.11 | D | 1.29 | C | 7.2 | B | 0.05 |
| Example 16 | C | 0.07 | D | 1.29 | D | 0.11 | D | 1.28 | C | 9.5 | C | 0.07 |
| Example 17 | C | 0.08 | D | 1.28 | D | 0.11 | D | 1.28 | D | 11.5 | C | 0.08 |
| Comparative | D | 0.10 | D | 1.25 | E | 0.14 | D | 1.29 | D | 11.5 | D | 0.10 |
| Example 1 | | | | | | | | | | | | |
| Comparative | D | 0.11 | E | 1.24 | E | 0.14 | E | 1.24 | E | 21.5 | D | 0.11 |
| Example 2 | | | | | | | | | | | | |
| Comparative | E | 0.13 | E | 1.22 | E | 0.15 | E | 1.22 | E | 25.3 | E | 0.12 |
| Example 3 | | | | | | | | | | | | |

Comparative Example 1 used strontium titanate as the inorganic fine particles, but the strontium titanate fine particles were merely surface-treated with methyltriethoxysilane. As a result, the work function was 5.60 eV, which did not reach the targeted value of the present disclosure.

Comparative Example 2 used silica instead of strontium titanate. Even though the inorganic fine particles were treated with a silane coupling agent and silicone oil, the work function was 5.50 eV. Thus, it was evaluated to be insufficient.

Comparative Example 3 used titanium oxide instead of strontium titanate. Even though the inorganic fine particles were treated with a silane coupling agent and silicone oil, the work function was 5.45 eV. Thus, it was evaluated to be insufficient.

The present disclosure can provide a toner with excellent chargeability that enables high image quality and can consistently produce high-quality printed results, even when output is made in a large quantity at a high speed over a long time.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-120910, filed Jul. 26, 2024, which is hereby incorporated by reference herein in its entirety.

What is claimed is:

1. A toner comprising:
toner particles individually containing a binder resin and a coloring agent; and
strontium titanate fine particles,
the strontium titanate fine particles having a work function of 5.65 eV to 7.00 eV.

2. The toner according to claim 1, wherein the strontium titanate fine particles are produced in a wet process.

3. The toner according to claim 1, wherein the strontium titanate fine particles are treated with a silane coupling agent and silicone oil.

4. The toner according to claim 3, wherein the silane coupling agent is an alkyltrialkoxysilane containing an alkyl group with 3 to 6 carbon atoms.

5. The toner according to claim 3, wherein the silicone oil has a viscosity of 1.0×10⁻⁷ m²/s to 0.1 m²/s at 25° C.

6. The toner according to claim 1, wherein the strontium titanate fine particles have a number average particle size of 5 nm to 50 nm.

7. The toner according to claim 1, wherein an amount of the strontium titanate fine particles in the toner is 0.1% to 5.0% by mass.

8. The toner according to claim 1, wherein the toner particles individually contain the strontium titanate fine particles.
